(19) United States
(12) Patent Application Publication
(10) Pub. No.: US 2006/0255099 A1
(43) Pub. Date: Nov. 16, 2006

(54) Method for welding components as well as a rotor manufactured based on this method

(76) Inventors: Werner Balbach, Wuerenlingen (CH); Sorin Keller, Oberrohrdorf (CH)

Correspondence Address: CERMAK & KENEALY LLP, 515 E. BRADDOCK RD, SUITE B, ALEXANDRIA, VA, 22314, US

(21) Appl. No.: 11/261,765

(22) Filed: Oct. 31, 2005

Related U.S. Application Data
(63) Continuation of application No. PCT/EP03/50164, filed on May 14, 2003.

(30) Foreign Application Priority Data
Nov. 25, 2004 (WO) 2004/101209

(51) Int. Cl. B23K 20/12

(52) U.S. Cl. 228/114.5

(57) ABSTRACT

The invention concerns a method for welding a first component (1) that is made of a superalloy on nickel, ferronickel or cobalt basis, to a second component (2) that is made of high-alloy, high-temperature steel. The method is characterized in that first an intermediate piece (5) made of high-temperature steel is attached to the welding surface (6) of the first component (1) by means of friction welding and by welding the intermediate piece (5) onto the first component (1) while exerting force (F) on and simultaneously turning the intermediate piece (5) and that the first component (1) with the intermediate piece (5) then is welded to the second high-temperature steel component (2) by means of a known fusion welding method.

### TECHNICAL FIELD

The invention relates to the field of materials engineering. It concerns a method for welding a first component that is comprised of a superalloy on the basis of nickel, ferronickel or cobalt, to a second component that is comprised of a high-alloy, high-temperature steel. These components above all are discs, drums and shaft end pieces for manufacturing rotors for turbomachines. The invention also concerns a rotor manufactured based on this method.

### STATE OF THE ART

The efficiency of thermal turbomachines can be improved by increasing the working temperature. Therefore, if operating at working temperatures above approx. 600° C., rotors of thermal turbomachines advantageously should be manufactured based on a superalloy, for example a superalloy on nickel basis. On one hand such superalloys have excellent properties at high temperatures, but on the other hand they are considerably more expensive than customary high-temperature steel. Since, however, rotors have sections that are subject to different thermal stresses, the state of the art is to only manufacture high temperature parts with superalloy for cost reasons and to manufacture parts that are subject to less thermal stress with high-temperature steel. This requires that the parts made of high-temperature steel be joined with the parts made of superalloy. This can be accomplished mechanically with screws, for example, or by welding the discs together.

U.S. Pat. No. 4,086,690, for example, describes the manufacture of a rotor comprised of individual discs that are welded together but that are made of the same type of material. The known tungsten inert-gas welding (TIG welding) and/or submerged arc welding methods are equally suitable as welding methods for welding the rotor discs.

It is known that high-temperature martensitic/ferritic steel, especially the 12% chrome steel class, is hard to weld with superalloys on nickel, ferronickel or cobalt basis. Depending on the welding method used, fractures in the base material, the heat affected zone or the welding deposit could develop (J. Tösch and E. Perteneder: Beeinflussung des Ferritgehaltes im austenitischen Schweissgut, sowie Einsatzgebiete verschiedener umhüllter, hochlegierter Stabelektroden. [Effect on the Ferrite Content in Austenitic Welding Deposit as well as Range of Application of Various Coated, High-Alloy Stick Electrodes], Presentation, Schweisstechnische Tagung Böhler Schweisstechnik Austria GmbH, Kapfenberg 1996). These fractures are undesirable since welding seams must be free of flaws. Due to the high mechanical and thermal stress this especially applies to welded rotor parts. Fusion welding between superalloy discs and discs made of high-temperature steel therefore is not used for stationary turbomachines because superalloys tend to develop fractures at high temperatures.

Buffers with superalloy materials such as disclosed in DE 101 12 062 A1 cannot easily be checked with ultrasound, which is a disadvantage, and in addition they are susceptible to fractures just like the corresponding base materials.

Buffers with ferritic/martensitic steel also are susceptible to fractures at high temperatures at the transition zone to the superalloy. It is possible to reduce the susceptibility to fractures due to heat by using weaker supplementary materials that, however, often do not meet the strength requirements of the joint and could have a negative effect on the bending deflection behavior of the rotors.

It is known to use friction welding for lower weights and/or thin wall thickness to join superalloys and high-temperature steel. However, friction welding cannot be used for stationary turbomachines with a rotor weight up to 100 tons and corresponding wall thickness at the joint (welding seam depth ≧200 mm).

### SPECIFICATION

The object of the invention is to develop a method for welding a first component that is made of a superalloy on nickel, ferronickel or cobalt basis, with a second component that is comprised of high-alloy, high-temperature steel, in which the above components, especially discs, drums and shaft end pieces of rotors are for thermal turbomachines and in which the weld joints meet the stringent criteria with regard to strength and testability.

According to the invention this is achieved with a method according to the preamble of claim 1 based on the following steps:
Application of an intermediate piece made of high-temperature steel on the welding surface of the first component by means of friction welding, by welding the intermediate piece to the first component and applying force and simultaneously turning the intermediate piece and
subsequent welding of the first component with the welded intermediate piece to the second component made of high-temperature steel by using a known fusion welding method.

The advantages of the invention are that large and heavy components made of the above material combinations now can be welded together very well. This fulfills the stringent quality requirements that apply to welded rotors of turbomachines due to high thermal and mechanical stress, for example. The weld joints can easily be tested with ultrasound methods.

It is practicable to counterclockwise rotate the intermediate piece and the first component onto which the intermediate piece is to be attached by means of friction welding because this results in an especially good friction-welding joint. However, it is not necessary. It might be sufficient to rotate the lighter intermediate piece and to keep the heavier component still.

Furthermore, it is advantageous when the first and second components are discs and/or drums and/or shaft end pieces of rotors for thermal turbomachines and the intermediate piece is a ring.

Furthermore, it is advantageous when the fusion welding method used is known for rotor welding such as TIG and/or submerged arc welding. The applicant has successfully been using these reliable methods for decades.

Finally it is practical if corresponding rings made of high-temperature steel are applied to both sides of a superalloy intermediate disc by means of friction welding.

### SHORT DESCRIPTION OF THE DRAWINGS

The drawing shows an exemplary embodiment of the invention.

The following is shown:

FIG. 1 shows a schematic view of a longitudinal section of rotor discs and shaft end pieces that are welded together according to the method of the invention to form a rotor of a turbomachine;

FIG. 2 shows a section of FIG. 1 that contains the step of friction welding the intermediate piece and

FIG. 3 shows another section of FIG. 1 with the assembly of the rotor made of superalloy discs and discs made of high-temperature steel.

Identical positions have the same reference numbers in the Figures. The arrows indicate the direction of movement of the parts.

### WAYS FOR EXECUTING THE INVENTION

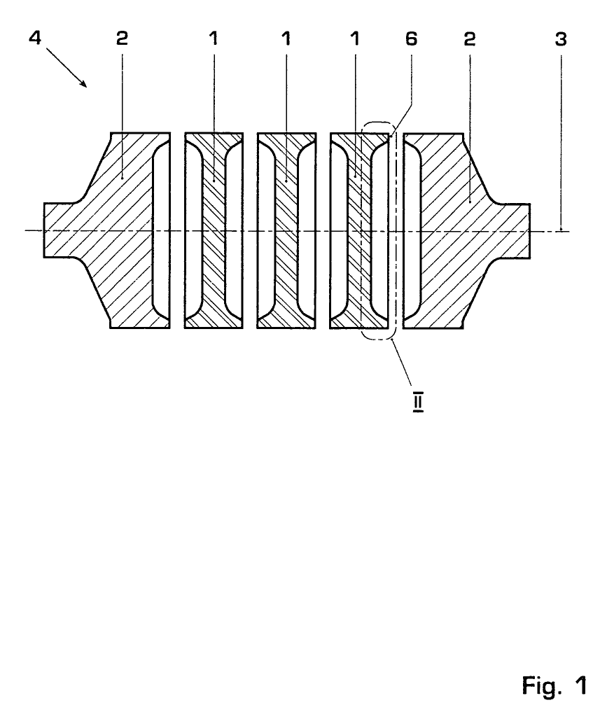

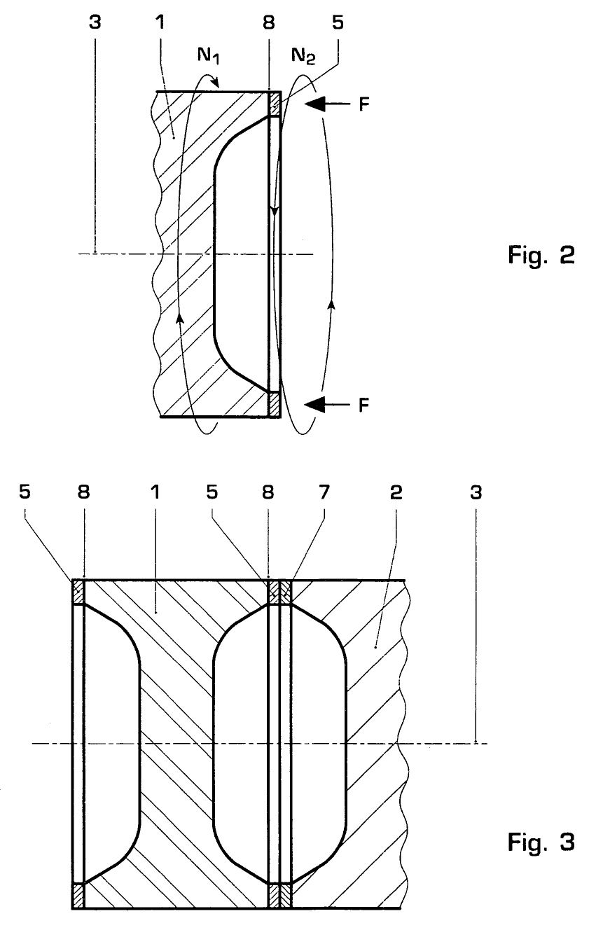

In the following paragraphs the invention is explained in more detail based on exemplary embodiments and FIGS. 1 and 3.

FIG. 1. shows the schematic view of a longitudinal section of rotor discs and/or drums made of superalloy and shaft end pieces made of high-alloy, high-temperature steel. The rotor discs made of superalloy make up the first component 1 and the shaft end pieces make up the second component 2. The first component 1 can be made of the known superalloy IN706 (ferronickel basis with the following main alloy elements in weight-%: 15-18 Cr; 40-43 Ni; 1.5-1.8 Ti; 2.8-3.2 Nb, remainder Fe). However, other superalloys on nickel, ferronickel or cobalt basis are suitable as well. The second component 2 in this exemplary embodiment is made of St13TNiEL with the following chemical composition (in wt.-%): 0.10-0.14 C, ≦0.15 Si, ≦0.25 Mn, 11-12 Cr, 2-2.6 Ni, 1.3-1.8 Mo, 0.2-0.35 V, 0.02-0.05 N, remainder Fe.

Components 1 and 2, i.e. the rotor discs or rotor drum respectively and the shaft end pieces are to be welded together according to the method of the invention to form a rotor 4 of a turbomachine with the rotor being pivoted around a rotor axis 3.

To this end the steps shown in FIGS. 2 and 3 are carried out.

According to FIG. 2, first a thin intermediate piece 5 that is a ring made of high-temperature steel in this exemplary embodiment, is attached to the welding surface 6 of the first component 1 by welding it onto the first component 1 by means of friction welding and by exerting force F on and simultaneously turning intermediate piece 5. The result is a friction weld joint 8. The first component 1 can either be stationary, i.e. can be a stationary disc or it can rotate, as indicated by the arrow in FIG. 2. Advantageous is a rotation in opposite direction of component 1 and an intermediate piece 5 that is to be welded on because this results in an especially stable friction weld joint. Of course it is possible for parts 1 and 5 to rotate with different numbers of revolutions N₁ and N₂ respectively. The intermediate piece 5 made of high-temperature steel that is attached to superalloy component 1, in particular to the annular welding surface 6 by means of friction welding, is used to facilitate the subsequent process step, i.e. the joining of component 1 and component 2 by means of fusion welding. The intermediate piece 5, in this case the ring, can also be premachined. In particular, the seam can be prepared for subsequent fusion welding on the intermediate piece prior to friction welding.

FIG. 3 shows how rotor 3 is assembled based on components 1 and 2. Following the first process step, i.e. the friction welding described above, the first component 1 with the intermediate piece 5 is welded to the second high-temperature steel component 2 by means of a known fusion welding method such as TIG or submerged arc welding. Such methods for welding rotors for turbomachines that the applicant has developed are described in publications DE 26 33 829 and EP 665 079 B1, for example, and do not need to be addressed in detail here. The intermediate piece 5 is connected with the shaft end piece (component 2) via this customary weld joint (weld seam) 7. FIG. 3 shows that an intermediate piece 5 can be attached to both sides of the first component 1 by means of friction welding so that both ends of component 1 on superalloy basis can be welded to components 2 made of high-temperature steel. These components 2 do not necessarily have to be shaft end pieces but can be rotor discs instead, for example.

The advantages of the invention are that large and heavy components made of the above material combinations (superalloy and high-temperature steel) now can be welded together well. Susceptibility to heat fractures is very low. This fulfills the stringent quality requirements for welded rotors of turbomachines due to the high thermal and mechanical stresses. The weld joints can easily be tested with ultrasound methods.

The described method in accordance with the invention is especially suitable for joining discs and other rotor parts for rotors of turbomachines, for example gas turbines or steam turbines.

### REFERENCE LIST

1 first component
2 second component
3 rotor axis
4 rotor
5 intermediate piece
6 welding surface
7 customary welding seam
8 friction weld joint
N₁ number of revolutions of the first component
N₂ number of revolutions of the second component

1. A method for welding a first component that is made of a superalloy based on nickel, ferronickel, or cobalt, to a second component that is made of high-alloy high-temperature steel, the method comprising:
attaching an intermediate piece made of high-temperature steel to a welding surface of the first component by friction welding and by welding the intermediate piece onto the first component while exerting force on and simultaneously turning the intermediate piece; and
welding the first component with the intermediate piece to the second high-temperature steel component by known fusion welding.

2. A method according to claim 1, wherein friction welding, comprises rotating the first component and the intermediate piece in opposite directions during.

3. A method according to claim 1, wherein the first component and the second component comprise discs or drums and shaft end pieces of rotors of thermal turbomachines, and wherein the intermediate piece comprises a ring.

4. A method according to claim 3, wherein fusion welding comprises TIG welding submerged arc welding, or both.

5. A method according to claim 3, wherein the first component comprises an intermediate disc of the rotor, and wherein attaching comprises attaching corresponding intermediate pieces, made of high-temperature steel to both sides of the welding surface by friction welding.

6. A rotor of a thermal turbomachine, comprising:
a first component made of superalloy and having a welding surface; and
a second component made of high-temperature steel, wherein the first and second components are joined by a welding seam; and
an intermediate piece made of high-temperature steel attached to the first component welding surface by friction welding, the intermediate piece arranged between the welding seam and the first component.

7. A method according to claim 5, wherein the intermediate pieces comprise rings.
